(19) United States
(12) Patent Application Publication
(10) Pub. No.: US 2014/0164216 A1
(43) Pub. Date: Jun. 12, 2014

(54) Financial Instrument and Method for Asset Financing in Stressed Markets

(71) Applicant: Chatterjee Manjirnath, San Francisco, CA (US)

(72) Inventor: Chatterjee Manjirnath, San Francisco, CA (US)

(21) Appl. No.: 13/895,176

(22) Filed: May 15, 2013

Related U.S. Application Data
(60) Provisional application No. 61/646,912, filed on May 15, 2012.

(51) Int. Cl. G06Q 40/02

(52) U.S. Cl. CPC G06Q 40/025
USPC 705/38

(57) ABSTRACT

The financial markets for housing or large secured assets can handle failures of payment arrangements of individual properties easily when the asset can be sold under normal market conditions or if the asset is worth more than any outstanding financed portion or loan. However if the borrower can no longer make payments and the market for such assets is unable to support a sale which pays off the principal either the borrower or lender may incur substantial losses. The present invention and method provides means under which both borrowers and lenders can re-finance the asset to provide sustainable payment schedules for the borrower while minimizing real financial losses for both the lender and borrower without any outside capital injection. The present invention further avoids both concepts of moral hazard (rewarding the wrong behavior) and social hazard (avoiding neighborhood blight) by providing lower financial losses and maintain high home asset ownership.

### RELATED APPLICATIONS

This patent claims the benefit of U.S. provisional patent application No. 61/646,912, filed on May 15, 2012, which is hereby incorporated herein by reference in its entirety.

### FIELD OF THE DISCLOSURE

This disclosure relates generally financial instruments for large assets, such as houses, which are typically arranged through mortgage financing.

### BACKGROUND

Mortgages are typically used to arrange financing for both consumer housing and commercial real-estate. Typically the property purchaser will arrange financing through a bank to acquire the property in exchange for a loan instrument in which the borrower makes payments over a period of time (such as 30 years) to pay off the debt as per the loan agreement. Sometimes the borrower is unable to make the payments. In these cases the lender may force the sale of the home (asset) to recover the principal of the loan or the lender may repossess the home. However this can only work when the property is worth more than the amount borrowed if the property has devalued or the market for such assets has collapsed then the lender may be unable to sell the property without sustaining a large loss of principal. Such was the case of the 2008 financial crisis. In this scenario borrowers were often “underwater” meaning that the amount that they owed was substantially less than the amount the property would fetch if sold on the open market. While per se this would not affect the loan arrangement between a homeowner/borrower and the lender, if the borrower could not make payments the following conundrum would ensue. Since the lender has the right to claim the property (through the foreclosure or short-sale process) the lender could take the property back from the delinquent borrower and then sell the home for what the market would bear. However since the whole market had also collapsed this meant that the lender would not be able to make reclaim the principal amount borrowed. During a normal time the lender would make back their principal amount but here the lender would also be realizing a loss. A secondary effect also developed—since the market was depressed whole neighborhoods would find themselves with distressed houses which were abandoned moving the problem from being one of a few bad home-buying arrangements to a neighborhood wide blight.

It is in societal interest to have a financial system which is strong in that it allows proper home purchasing and also a social system which is strong which allows neighborhoods to remain intact regardless of the price of homes in general on the free market. Related to the 2008 crisis was improper home lending practices and a “bubble” of home valuation which exacerbated these problems for lenders, borrowers, and neighborhoods. Several solutions were proposed either from government agencies or societal pressure to either forgive loan principal amounts, reduce financing terms (e.g. lower existing loan interest rates), or short sale properties.

Any of the interventions would work if either the home was appreciating as in most normal market conditions or if the loan amount outstanding meant that the parties could be made whole by simply selling the property. At a societal level three broad hazards exist if too many distressed properties enter the market at the same time. The first hazard is the market for such assets will collapse causing a severe price downturn for such assets. This can be viewed as a simple market correction for the asset category, in this case the housing market. However the next two concerns are much broader and can literally destabilize an economy or even a neighborhood or society. The issue of moral hazard is that by forgiving distressed loan principal amounts or providing related outside assistance that distressed loan arrangements are rewarded while those making good on their payments are effectively penalized because they are not eligible for the assistance given to their distressed counterparts. This can encourage borrowers in good stead to demand a deal comparable to their distressed peers further collapsing the market and encouraging “bad” behavior from a socio-economic point of view. The issue of social hazard occurs when society does not find a way to deal with a market collapse gracefully essentially resulting in bankrupted neighborhoods with large tracts of abandoned or neglected houses—in other words simply doing nothing and waiting for a market to fix itself can cause severe lasting damage to areas.

The invention described herein provides a way for borrowers and lenders to work together, without outside financial assistance (such as government funds for principal forgiveness) to work out a payment mechanism which minimizes both the moral and social hazards as described.

### BRIEF DESCRIPTION OF THE DRAWINGS

FIG. 1 represents a typical standard loan financing agreement. Different types of loan arrangements are possible such as 30 year fixed and Adjustable Rate Mortgage (ARM) as are known in the art. However all follow the pattern shown here, the borrower (purchaser of the house) finances a portion of the cost and then pays this off over time. This is seen in box 100 where the borrower has purchased a home. The shaded portion represents the equity (down payment) of the borrower at time of purchase, while the rest of the home is financed via the loan process which is represented by the non-shaded portion. As time progresses and the borrower makes payments they gradually own more of the home as shown in box 110. At the completion of the loan repayment the borrower now owns the entire home.

FIG. 2 represents symbology used in the rest of this application. The shading scheme of box 200 represents borrower equity as percentage of the home owned via the financing process. The shading scheme of box 210 represents outstanding loan principle. The shading scheme of box 220 represents partial-parcel ownership owned by the lender. The shading scheme of box 230 represents partial-parcel ownership as owned by outside investors or 3^{rd} parties. See Description section for more details. Box 240 shows a representive home ownership scenario using the shading schemes and is supplied for example purpose only.

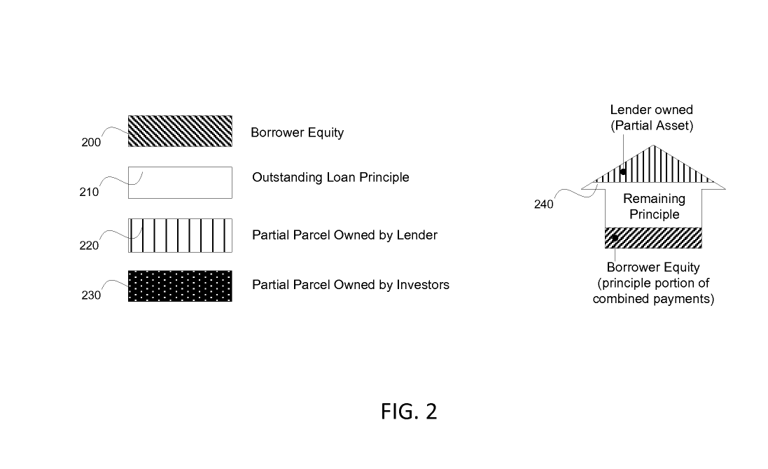

FIG. 3 depicts the Shared Risk Asset Financing scenario as a stand-alone process. In box 300 the home is purchased and financed in a normal way. However due to market conditions the borrower may not actually own any of the property (this is called zero percent down). In this situation, external factors may motivate the buyer (borrower) to walk away from the property and financing arrangement. In box 310 the borrower and lender have come to agreement to refinance the property using the SRAF method as described herein. Now the lender owns a portion of the home while the borrower also owns a portion and the remaining is financed by the borrower. Box 320 represents the same arrangement as box 310 however due to the passage of time and regular payments by the borrower, the borrower is now owns a larger portion of the house. After more time has passed and assuming the borrower has made regular payments the box 330 is reached. In this situation the borrower now has paid off their SRAF loan and the home is co-owned between the borrower and the lender. In box 340 the borrower arranges to purchase the remaining portion of the home with a new agreement with a new valuation of the remaining portion. At this time the loan is again a standard loan arrangement. In box 350 the borrower has paid off all loan instruments and is now the full owner of the property.

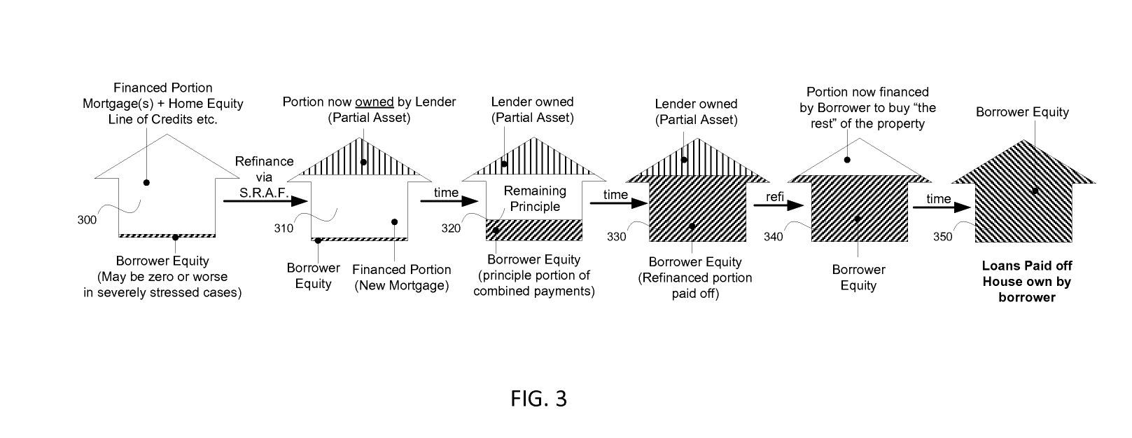

FIG. 4 Box 400 represents a Partial Asset Backed Security (PABS) pool visually. Here partial assets (home portions) are owned by a collective. A PABS may own 1 or more partial homes (or even full homes). Each portion may represent a varying percentage of the individual homes sold—in other words some partial assets may be 10% of a home while others could be 30% of a home.

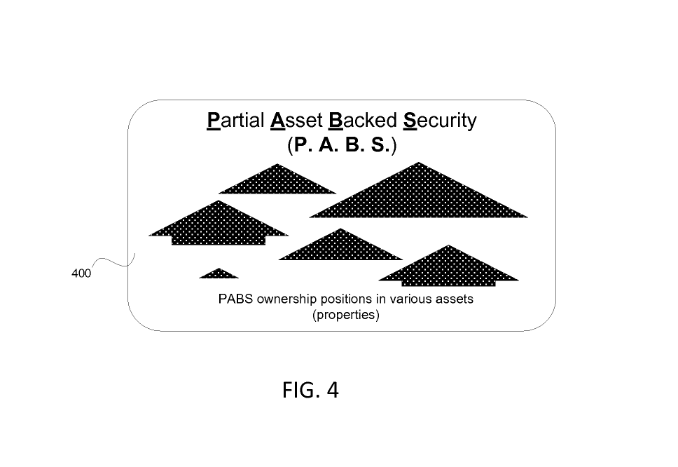

FIG. 4a represents different scenarios under which a PABS can exit from holding a particular property in its pool. In box 410 which represents asset exit scenario 1, the borrower elects to buy the remaining portion of their property. This gives cash to the PABS while the borrower finances the asset (remaining portion of their home) using conventional financial instruments such as home loan. Box 420 represents a scenario where the entire property is sold on the open market and the proceeds of the partial asset from the sale are provided to the PABS holders. Box 430 represents a scenario where the Partial Asset is sold to other concerns, for example another PABS agency.

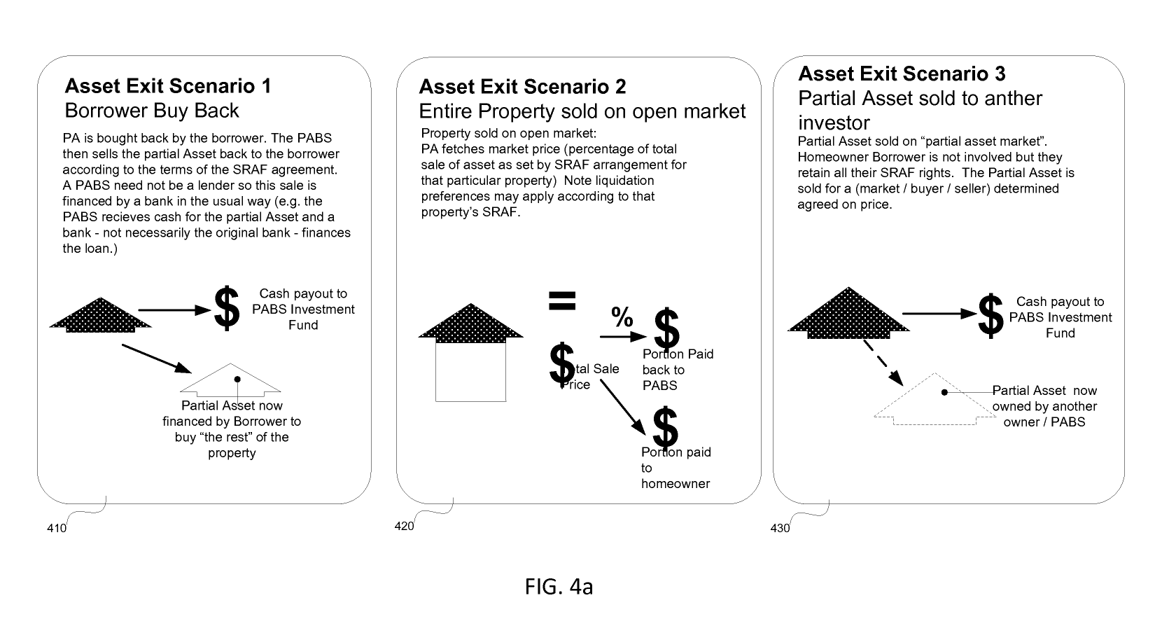

FIG. 5 represents the entire method and system as a single diagram and flow. Boxes 300 to 350 are the same as in FIG. 3. However box 500 shows the integration of the PABS in to the system. Here the portion owned by the lender of box 310 is sold to a PABS pool as in box 510. Once this is completed the PABS owns this portion of the home and the lender is paid off whatever agreed price the PABS and lender agree to. Box 520 shows the home owner continuing to make payments on their portion of the house while the PABS holds the formerly lender owned portion. While in this state the PABS owned portion may change hands at various prices between different investor groups. In box 530 the borrower has paid off their portion of the home asset but the ownership is now split between the PABS and the homeowner instead of a lender and the home owner (borrower). At any time the home owner can assert their purchase rights to the remaining portion of the property which is represented by paths 540 and 550. These paths both lead to the home being financed via conventional loan instruments. Box 590 represents a legend for the shadings used in the diagram.

FIG. 6. Represents of summary of financial methods available for distressed assets when the market is functioning normally.

FIG. 7. Represents a summary of financial methods available for distressed assets when the market is stressed and depicts, in summary form the advantages of the present invention.

### DETAILED DESCRIPTION OF THE INVENTION

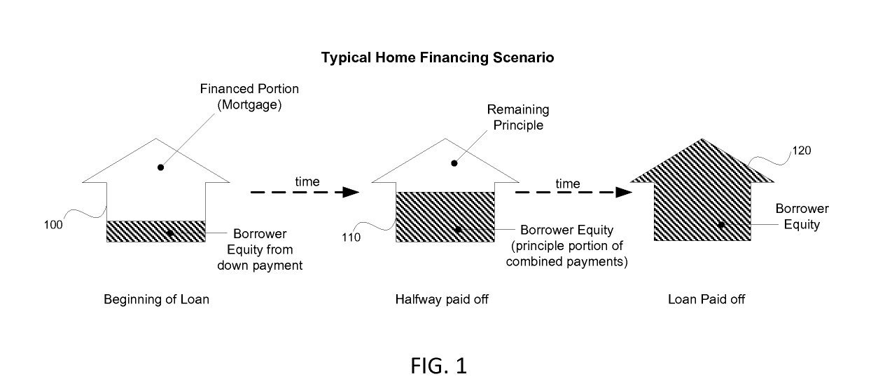

In FIG. 1 a standard loan type arrangement is depicted. Here a home buyer purchases a home by putting some money as a down payment and then making regular payments over time to pay off the loan and eventually own the home. At any time the home buyer can also sell the house and using the proceeds pay off the remaining amount borrowed. As long as the sale price exceeds that of the remaining amount borrowed then the lender is made whole and the buyer has a clean transaction though the buyer's actual net gain or loss will depend on how much the home sells for relative to its original purchase price.

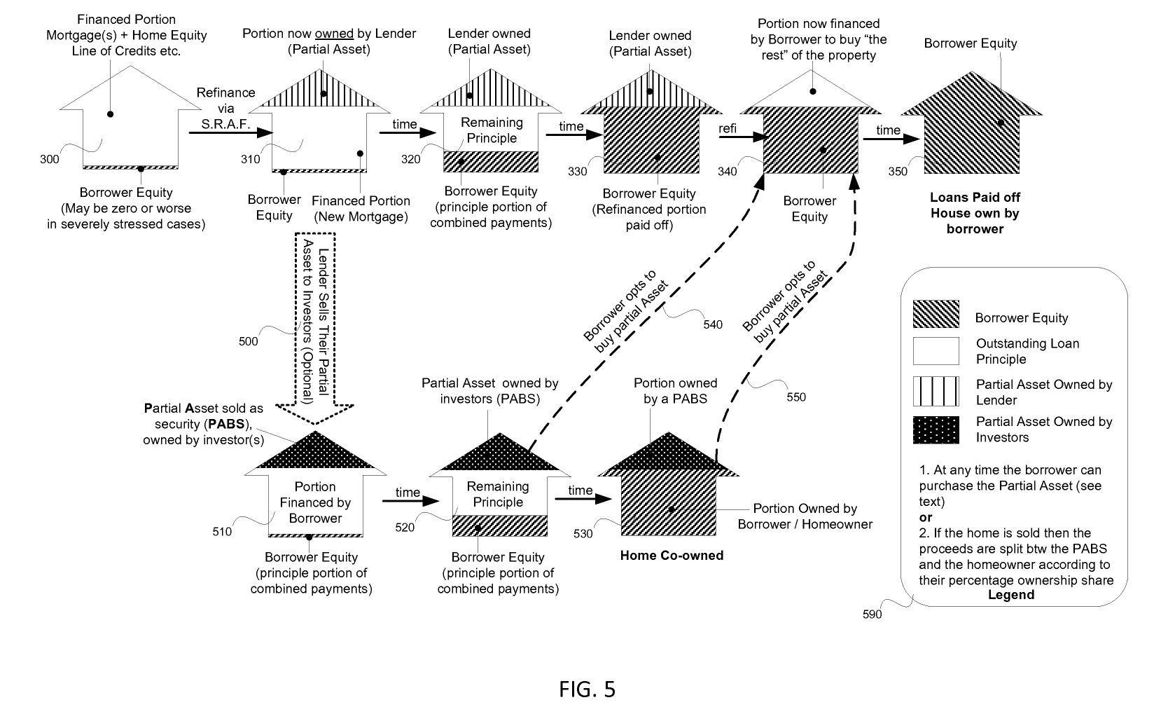

If the buyer is distressed for any reason and can't make the payments and also the amount the house will sell for is less than the outstanding loan balance then selling the house leave the buyer with a debt. As mentioned in the background section, this is where the present method can be used to help both the home buyer keep their home and also minimize losses for the lender. In FIG. 5 this is shown in box 310. Here the borrower and lender “split the difference” of the amount owed. This allows the borrower to finance a smaller portion of the original debt as shown while the lender now owns (not just holds as collateral to a loan instrument) a portion of the asset. The borrower can now make payments which are more manageable. Should the property be sold at any time the proceeds are split between the two parties according to the agreed on ownership percentages. The exact ownership percentage which is held by the lender is determined as a contract negotiation between the lender and the borrower. As the borrower pays off their portion of the asset at any time they can repurchase the amount held by the lender according to an agreed upon appreciation schedule. This schedule can be that the lender portion value is increased as a fixed rate value (e.g. if the value of the lender portion as 20% of the original purchase price than each year it could increased according to some index such as the LIBOR rate). Another schedule option is to allow the home to be revalued according to one of several methods: home appraisal, average of rate of increase of comparables (e.g. take the median home price when the SRAF was established and take the median home price at the repurchase time and compute the ratio and apply to the lender portion to be repurchased).

In the example described herein, we will consider a typical homebuyer called Joe and his Bank. This also describes the preferred embodiment of the invention.

Joe bought a house for $200K in spring 2007, with no money down and had an interest only loan at 4%. This resulted in payments of $667 per month. Now he is at the end of the interest only portion of his loan (and hasn't paid down any principle) and his interest rate has reset to 6%. Since he will start to pay principle his resulting payment is $1199 per month. He can't afford the new payments and to make matters worse the value of the house is now approximately $130K. Since he still owes $200K he is $70 k underwater which represents 35% of outstanding loan principal should he try to sell it on the open market. If he defaults, turning the property back to the bank, then the bank would be forced to sell the house at approximately $130K taking net loss on principle less payments paid to date.

Rather than having the bank rent the house back to Joe (a current Bank of America program) or forgiving principal, Joe and the Bank refinance his property using a Shared Risk Asset Financing (SRAF) arrangement.

The Bank and Joe agree to reset Joe's loan to $120K (this amount can be chosen by the Bank and Joe for optimality). This represents 60% of Joe's original loan and as we will discuss in a moment, allows for refinancing to a portion he can afford. The other $80K of Joe's original loan will now convert into a percentage ownership share of Joe's property which will be held by the bank. In this case, $80K represents 40% of the original loan and hence converts in to the 40% share of the property. This results in the following:
Joe now has a new 30 year fixed rate loan, of $120 k with the bank for which he will own 60% of the property when he is finished with the loan. Joe's new loan has a fixed interest rate of 5.3% resulting in payments $667 per month—the same as his previous payment.
The Bank now has 40% stake in the property. Even when Joe pays off his new loan the bank will still own 40% of the property.

This allows Joe to make his payments while allowing time for the property to appreciate. Should the property be sold, Joe will receive 60% of the sale and the Bank will receive the other 40%. The longer Joe can stay in his house the more likelihood that the home will appreciate putting both Joe and the Bank ahead.

Ten years from now Joe decides to buy the remaining portion of his home. Using one of several appreciation schedules (more on this later) the Bank's portion has been allowed to grow at 5.3% (same rate as Joe's loan). This results in the bank's portion now being worth $134,083. Joe can finance to purchase the Bank's equity with a standard loan product at that time. We will also look at options for when the Bank does not want to hold the equity portion of Joe's home in more detail.

This also allows the following objects and advantages:
No principle write down from the bank/No external bailout required
Joe can stay in his house
Both parties may be able to fully recover financially when the house is sold at some time in the future or Joe exercises his right to buy the Bank's portion.
The financing arrangement is internal—no dependency on market values is required.

This solves the first portion of the problem—working out a payment system which Joe can afford without resorting to selling the property when the market for such properties is distressed. However the Bank is now holding a portion of Joe's house which is illiquid. A tenet of the bank loan process is that the banks try to minimize illiquid assets so that they can free their cash to sell other loan and financing instruments.

Joe's house is an asset and the bank owns a partial asset (since it only owns a portion of Joe's house). In a normal loan, once the payments are completed the bank has all its money back and hence can invest its capital in other ways. To allow the bank to exit this illiquid asset we must introduce a way for the bank to sell its ownership stake in Joe's house to an outside investor. We will call the bank's portion of Joe's house a Partial Asset as it represents a fractional ownership share of Joe's house. What is now introduced is a to sell this Partial Asset so that the lending institution can maintain liquidity. In box 500 we see this process take place. The lender can sell its Partial Asset to investors. The amount the lender will receive is solely dependent on the negotiation with investors who may demand a premium or pay below what the partial asset was originally valued at when the Joe originally bought the house and arranged financing. However for the lender, even if this sale is at discount valuation compared to what the Partial Asset was worth when the home was originally purchased it still represents substantially less loss than should the entire property have been short sold or foreclosed. For the investor it provides a secured asset which if left over a longer period of time should appreciate when market forces allow the property to be sold under non-stressed (normally functioning) conditions.

In fact many of these partial assets can be bundled in to a security which we will call a Partial Asset Backed Security (PABS). While conceptually similar to a Mortgage Backed Security (MBS), where bundles of loans/mortgages are sold as investments based on loan repayment, in a PABS is backed by the actual property ownership. However the as the name implies, the PABS is only a ownership portion in a part of Joe's house. When the bank sells this ownership stake as an investment (Partial Asset), it receives cash just as if Joe had paid off the partial parcel.

The PABS acts like any pooled investment vehicle however instead of a mutual fund which owns stocks, the instrument of trade is partial assets. When Joe sells his house on the open market then the PABS receives the proceeds based on Joe's SRAF arrangement. A PABS can even re-sell a given asset on the open market to another investor for whatever price they (the PABS and investor) agree on without affecting Joe's SRAF arrangement. At any time Joe can opt to buy the rest of his home from the then-current investor per his SRAF contract appreciation schedule.

Should Joe exit his SRAF agreement early (e.g. less then a year and the property is still in distress) the SRAF may have liquidation preferences written in for the partial asset holder whether this is the SRAF lender with whom Joe worked or whether it is an unrelated owner of the Partial Asset.

Lastly a large institution (e.g. Wells Fargo or Bank of America), may have both banking and investment arms. Here the banking arm can refinance the loan using the SRAF system and then sell (even at a loss) the partial asset to a PABS in the investment arm. The SEC requires banks to have minimum financial strength measures so by moving the Partial Assets from the banking arm to an investment arm it will be easier for the bank to document its liquid financial strength to regulators. The investment arm, which has different capital requirements, simply maintains ownership of the asset as it would any other commodity.

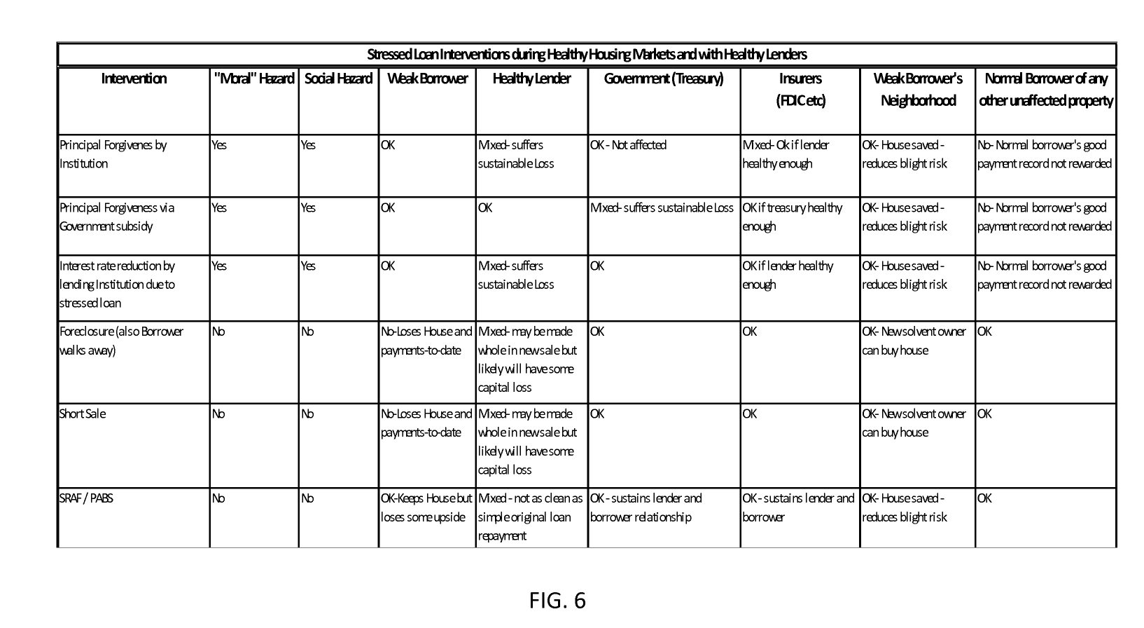

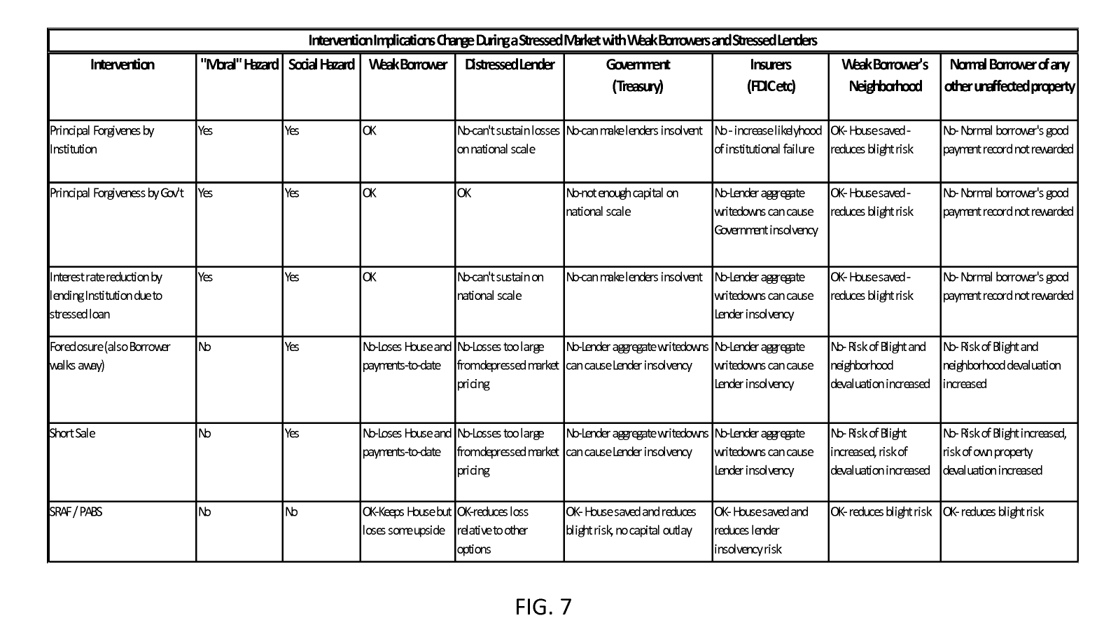

FIG. 6 and FIG. 7 show the effectiveness of the present invention at financing distressed housing during a time when the market has collapsed. Here the SRAF+PABS financing method described herein minimizes losses for both lenders and borrowers even if the asset cannot be immediately sold on the free market.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method to finance a distressed asset, comprising a shared asset ownership system with:
A loan instrument in which the borrower finances a portion of the asset;
A deed of partial ownership in which the lender lays claim to a partial ownership of the asset;

2. A method as defined in claim 1, wherein said asset is a real estate property

3. A method as defined in claim 1, wherein said asset is a house

4. A method as defined in claim 1, wherein said asset is a condominium

5. A method as defined in claim 1, wherein the borrower and lender consolidate several loan instruments comprising any of the following: a primary mortgage, a home equity loan, outstanding principal amounts due, outstanding leans due, outstanding penalty payments due, in to a instrument comprising a borrower financed loan and a lender owned partial asset deed of ownership.

6. A method as defined in claim 1, wherein when the borrower has paid off their portion of the loan of the asset they can finance, using any loan type instrument, the purchase of the remaining asset which is owned by the lender.

7. A method as defined in claim 1, wherein the borrower is responsible for homeownership expenses and maintenance

8. A method as defined in claim 1, wherein the borrower is responsible for paying ownership taxes on the asset.

9. A method as defined in claim 1, wherein the the borrower and the partial asset owner reach a schedule for apportioning payment for homeownership fees and maintenance

10. A method as defined in claim 1, wherein the the borrower and the partial asset owner reach a schedule for apportioning payment for paying ownership taxes on the asset.

11. A method as defined in claim 1 where if the asset is sold on the open market to an outside party not comprising the lender or the partial asset owner or any of their agents that the proceeds of the sale shall be split according to the ratio of the original shared asset financing as agreed to by the borrower and the partial asset owner.

12. A method as defined in claim 1, wherein the lender can sell their partial ownership to another party.

13. A method as defined in claim 1 where should the lender sell their partial asset ownership to another party the borrower can, upon reaching terms with said other party, can elect purchase the remaining ownership interest from said party.

14. A method as defined in claim 13 above in which said loan schedule is a adjustable rate mortgage instrument

15. A method as defined in claim 13 where said loan schedule is a fixed rate loan.

16. A method as defined in claim 1 where any of the owners of partial assets can buy and sell partial asset ownerships

17. A method for creating agreements where the purchasing and selling of partial ownership assets is determined between the buyers and seller of the partial ownership assets.

18. A method for financing partial ownership between borrowers and lenders using an internal arrangement as defined in claim 1 and the selling partial ownership shares on a market for such exchange.

19. A method for valuing a partial asset based on the percentage change in median comparable assets over time.
